(19) United States
(12) Patent Application Publication
(10) Pub. No.: US 2025/0301325 A1
(43) Pub. Date: Sep. 25, 2025

(54) MULTI-LINK OPERATION LINK TRANSITION PROTECTION

(71) Applicant: HEWLETT PACKARD ENTERPRISE DEVELOPMENT LP, Spring, TX (US)

(72) Inventors: ANDRE BEAUDIN, St. Laurent (CA); OMAR EL FERKOUSS, St. Laurent (CA); JIANPO HAN, Beijing (CN)

(21) Appl. No.: 18/609,930

(22) Filed: Mar. 19, 2024

(51) Int. Cl. H04W 12/082; H04W 12/062

(52) U.S. Cl. CPC H04W 12/082; H04W 12/062

(57) ABSTRACT

Systems and methods are provided for protecting link transitions from anomalous behaviors on links formed between multi-link devices (MLDs) in multi-link operation (MLO). Examples detect, by a first MLD, an anomaly related to a second MLD based on receiving a plurality of link transition trigger signals from the second MLD. The second MLD having been authenticated for MLO with the first MLD. In response to detecting the anomaly the second MLD is de-authenticated for MLO with the first MLD. In some examples, while de-authenticated for MLO, the second MLD can then be authenticated for single-link operation (SLO).

### BACKGROUND

The seven-layer Open Systems Interconnection (OSI) model of computer networking includes the physical layer, the data link layer, the network layer, the transport layer, the session layer, the presentation layer, and the application layer. The physical layer is the first and lowest layer, and is the layer most closely associated with the physical connection between devices. The physical layer provides an electrical, mechanical, and procedural interface to the transmission medium. The shapes and properties of the electrical connectors, the frequencies to broadcast on, the line code to use, and similar low-level parameters are specified by the physical layer.

The data link layer is the second layer and is the protocol layer that transfers data between nodes on a network segment across the physical layer. The data link layer provides the functional and procedural means to transfer data between network entities and may also provide the means to detect and possibly correct errors that can occur in the physical layer. The data link layer is concerned with local delivery of frames between nodes on the same level of the network.

The Medium Access Control (MAC) sublayer is the layer that controls the hardware responsible for interaction with the wired, optical, or wireless transmission medium. The MAC sublayer and the Logical Link Control (LLC) sublayer together make up the data link layer. The LLC provides flow control and multiplexing for the logical link, while the MAC provides flow control and multiplexing for the transmission medium. When sending data to another device on the network, the MAC sublayer encapsulates higher-level frames into frames appropriate for the transmission medium (i.e. the MAC adds a sync word preamble and also padding if necessary), adds a frame check sequence to identify transmission errors, and then forwards the data to the physical layer as soon as the appropriate channel access method permits. When receiving data from the physical layer, the MAC block ensures data integrity by verifying the sender's frame check sequences, and strips off the sender's preamble and padding before passing the data up to the higher layers. Accordingly, the MAC layer can request services from the physical layer in a single network device.

The Institute of Electrical and Electronics Engineers (IEEE) 802.11 communication standards-more commonly referred to as Wi-Fi-specify a set of MAC and physical layer (PHY) protocols for implementing wireless local area network (WLAN) computer communication. The IEEE 802.11 protocol denotes a set of interface standards developed by the IEEE 802.11 committee for short-range communications. For example, the devices that implement the IEEE 802.11 protocol may have both 2.4 GHz and 5 GHZ radios for transmitting and receiving data and management frames between devices with similar radio configurations.

IEEE 802.11 is a set of IEEE standards that govern wireless networking transmission methods. They are commonly implemented as 802.11a, 802.11b, 802.11g, 802.11n, and 802.11ac versions to provide wireless connectivity in the home, office, and some commercial establishments.

IEEE 802.3 is a working group and a collection standards defining the physical layer and data link layer's MAC of wired Ethernet. This is generally a local area network (LAN) technology with some wide area network (WAN) applications.

IEEE 802.11be-more commonly referred to as Wi-Fi 7-is the successor to Wi-Fi 6/6E (IEEE 802.11ax) and promises to boost the speed and stability of wireless connections while offering lower latency and the ability to seamlessly manage more connections than prior.

MLO (Multi-Link Operation) is a MAC feature introduced in Wi-Fi 7. MLO enables devices to send and receive data across different frequency bands and channels, such as a 2.4 GHz band, a 5 GHz band, and a 6 GHz band. More specifically, MLO is a particular feature of the IEEE 802.11)be Extremely High Throughput (EHT) Wi-Fi 7 standard that allows network devices, like APs and client devices, the ability to transmit and receive data from the same traffic flow over multiple radio channels. For example, a first network device (e.g., the AP) may implement multiple radios, like a 2.4 GHz radio and 5 GHz radio, and each of these radios may communicate with a similar or overlapping frequency radios on a second network device (e.g., the client device). Accordingly, multi-link devices (MLDs) may communicate with one another using multiple links (e.g., 2.4 GHz, 5 GHz, 6 GHZ).

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of a network configuration that may be implemented in accordance with the present disclosure.

FIG. 2 illustrates an example multi-link device (MLD) communication.

FIGS. 3A and 3B show schematic diagrams of example signaling for data communications in a Multi-Link Operation (MLO) communication.

FIG. 4 depicts an example message flow diagram, reflecting operations performed for detecting anomalous behavior and protecting link transitions in MLO communications, in accordance with the implementations disclosed herein.

FIG. 5 is an example computing component that may be used to implement various features of link transition protection in accordance with the implementations disclosed herein.

FIG. 6 is an example computer system that may be used to implement various features of link transition protection in accordance with the present disclosure.

The figures are not exhaustive and do not limit the present disclosure to the precise form disclosed.

### DETAILED DESCRIPTION

Examples of the present disclosure provide systems and methods for optimization in Wi-Fi 7 using MLO. The technology disclosed herein provides mechanisms for protecting link transitions between links formed between MLDs from anomalous behaviors.

As alluded to above, Wi-Fi 7 (as defined by the IEEE 802.11be standards) provides for MLO, which increases throughput by leveraging multiple links (e.g., different frequency bands and channels) for the sending and receiving of data. As used herein, a multi-link device (MLD) is a type of network device that includes one or more radio chain interfaces that can leverage multiple links and is capable of MLO with another MLD. An AP MLD may operate support an MLO with a non-AP MLD. In one example, an AP MLD may configure multiple virtual APs (VAPs) to effectuate multiple radio chain interfaces, where each VAP functions as an radio chain interface. A non-AP MLD, also may be referred to as client device or station (STA) MLD, may configure one or more radio chain interfaces for MLO. The AP MLD and a non-AP MLD may establish a multi-link association in which multiple links are enabled between the AP MLD and the non-AP MLD. Each link of the multi-link association may be between a radio chain interface of the non-AP MLD and a particular radio chain interface of the AP MLD. The multiple links may be established using different channels, frequency bands, or spatial streams, among other examples.

A multi-link association may provide for establishing multiple links between MLD devices. For example, a AP MLD and a non-AP MLD may exchange setup and response frames, including requests for authentication for MLO and authentication responses, via a first link to provision or configure multiple links of the multi-link association. Thereafter, one link (which may be the first link or any of the other links established in the multi-link association) may be maintained as an active connection for signaling or network operations. In some implementations, the link that is maintained for signaling may be referred to as an active link, primary link, or other terms to differentiate that link from other links. The other links of the multi-link association may be referred to as non-active links, secondary links, or other such terms.

There are different types of MLDs based on the capabilities of the MLD. In some examples, an MLD may implement multiple radios and use these multiple radios concurrently for the MLO. These MLD devices may be referred to as multilink multi-radio (MLMR) MLDs. In other examples, an MLD may implement single radio configured to use multiple links. These MLD devices are referred to as multilink single-radio (MLSR) MLD. In the case of an MLSR MLD, the single radio may need to switch back and forth (e.g., transition) between multiple links, for example, in a time domain multiplex (TDM) fashion. The link transition operations of a single radio may require both extra time and extra signaling. Thus, the MLSR operation may allow an STA MLD to transition in a static fashion, e.g., the non-AP MLD may have to tune the radio onto one link (e.g., one band) for a data transmission session and then switch to another link. For example, the STA MLD may tune its radio to the 2.4 GHz band and transition to another band (e.g., a 5 GHZ band or a 6 GHz band). To provide more flexibility, the IEEE 802.11be standards has defined an Enhanced Multilink Single-Radio (eMLSR) operation, which enable an MLSR MLD to dynamically switch links to improve both throughput and latency performance. eMLSR enabled device may comprise a single radio having multiple antennas tuned to frequency bands of the multiple links.

As alluded to above, MLO may enable a larger amount of data throughput between MLDs because MLDs may be able to leverage different links of different throughput and single strength to transmit data on different links. However, various challenges can be presented in operating multiple links. For example, each link is associated with a different radio chain interface of the MLD, each of which may share an radio in the case of MLSR or eMLSR MLDs, and each chain consumes power when activated. To address the increased power consumption in operating multiple links, power saving techniques have been provided for MLO that dynamically activate/deactivate links through transitioning the active link to non-active link. Active links can be transitioned to a non-active when the link is not actively being used for sending or receiving data, and the link may be referred to as a non-active link. A radio chain interface corresponding to a non-active link can be disconnected from the network, for example by tuning a radio to a frequency band other than that of the non-active link (e.g., tuning the radio to a frequency band of the active link), while keeping the non-active link established between MLDs. In some examples, the radio chain interface may be disconnected from a power supply, while the link remains configured and enabled. As such, a non-active link may consume minimal power.

In an illustrative example, an AP MLD may transmit a beacon frame on an active link that indicates downlink (DL) data traffic is queued (e.g., buffered) for sending to a non-AP MLD. The beacon frame may include, for example, a traffic indication map (TIM) element or a multi-cast traffic indication element that specifies a link of the multiple links for sending the queued data. In the case, where the beacon frame specifies a non-active link, the non-AP MLD may transition the specified non-active link to an active link upon receipt of the beacon frame by waking the non-AP MLD and tuning the radio chain interface to the specified link. The non-AP MLD may be woken up from a power save state, in which the non-AP MLD is consuming minimal power because the non-AP MLD is not actively sending or receiving data on any link. Upon being woken up, the non-AP MLD may transmit a power save poll signal (also referred to as a PS Pol signal) to the AP MLD to trigger the link transition to the specified link. The above example may be performed in a case where the non-AP MLD is an MLSR MLD. In the case of an eMLSR MLD, the AP MLD may send a Request-to-Send (RTS) signal on an active link, which specifies a link for sending queued data traffic to the non-AP eMLSR MLD. The non-AP eMLSR MLD wakes up the radio chain interface corresponding to the specified link and sends a Clear-to-Send (CTS) signal to the AP MLD over the specified link, which triggers the link transition to the specified link. Thus, the ability to dynamically activate or deactivate links can be provide flexibility for power saving, while continuing to provide increased throughput.

In another example, a non-AP MLD may queue uplink (UL) data for sending to a AP MLD via a non-active link. In this case, the non-AP MLD may transmit a PS Poll signal in the case of a multi-link single radio (MLSR) non-AP MLD or a request to send (RTS) signal in the case of an enhanced MLSR (eMLSR) non-AP MLD to notify the AP MLD of the queued data. The PS Poll signal or RTS signal, in either case, may indicate a link over which the queued data is to be transitioned. Based on these signals, the indicated link can be transitioned from a non-active link to an active link by waking up the corresponding radio chain interfaces and data can be sent from the non-AP MLD to the AP MLD. As such, the ability to dynamically activate or deactivate links can be provide flexibility for power saving, while continuing to provide increased throughput.

In some cases, however, an anomaly may occur related to an MLD that may negatively impact performance in data communications between MLDs, for example, in terms of throughput and/or latency and may result in denial-of-service. For example, generally a non-AP MLD should wake up on the radio chain interface for a non-active link indicated by a AP MLD for DL data traffic (e.g., by the beacon frame or by the RTS signal). However, in some cases the non-AP MLD may wake up a radio chain interface corresponding to a different link. This issue could be a result in, for example, a de-synchronization between the AP MLD and the non-AP MLD. For example, conventionally the non-AP MLD may dictate on which link DL data is to be received from the AP MLD. This can be dictated through link transition trigger signal, such as, but not limited to, a PS Poll signal transmitted to the AP MLD by the non-AP MLD in the case of an MLSR MLD or by the RTS/CTS signals in the case of a eMLSR MLD. However, in some cases, an AP MLD may receive numerous repetitive link transition trigger signals from a non-AP MLD, which can flood the AP MLD with link transitions. The repetitive link transition trigger signals may be the result of the non-AP MLD waking up the radio chain interface of the wrong link or the non-AP MLD may be spoofing a link transition trigger signal for malicious intentions. Due to the flooding of link transitions, the AP MLD may have queued data traffic that it is unable to send, which can result in a denial-of-service for the non-AP MLD.

In another example, the non-AP MLD may be sending data packets having a traffic identifier (TID) on a current active link that does not match the TID mapped to the that link. A TID is an identifier used to classify a type of data contained in a data packet, such as audio, video, voice, data, and the like. Generally, the AP MLD and non-AP MLD negotiate a mapping of TIDs to established links during the setup of the multi-association, such that a given TID can be mapped to one or more of the established links. However, an anomaly may occur where the data packets transmitted by the non-AP MLD over an active link differs from the TID mapped to that active link. This could occur, for example, where PS Poll signaling indicating a link transition was missed by the AP MLD or otherwise not received by the AP MLD. As a result, there could be traffic queued at the AP MLD for the non-AP MLD, which the AP MLD is not able to transmit because of a flood of link transition, which can result in a denial-of-service for the AP MLD.

Examples of the presently disclosed technology provide for systems and methods that address the above technical problems by protecting link transitions in MLO by detecting anomalous behavior over a multi-link association between a first MLD and a second MLD and de-authenticating the MLO therebetween. Examples herein can detect anomalous behavior (sometimes referred to as an anomaly) pertaining to a second MLD based on receiving a plurality of link transition trigger signals from a first MLD. In various examples, the first MLD may be an AP MLD and the second MLD may be a non-AP MLD; however, implementations of the disclosed technology is not intended to be limited to this configuration only. A multi-link association between the first and second MLDs may be established by authenticating the second MLD for MLO at the first MLD. Once authenticated for MLO, the MLDs may exchange setup and response frames via a first link to provision or configure (e.g., establish) multiple links of the multi-link association. Yet, based on (e.g., responsive to) detecting an anomaly on one or more of the links, the first MLD may be de-authenticated for MLO, which may include tearing down or otherwise disbanding the multiple links and sending a de-authentication message frame to the second MLD. The second MLD can be required to re-authenticate itself with the second MLD, for example, by transmitting an authentication request to the first MLD. The first MLD may reject any authentication requests for MLO, and accept only an authentication request for Single-Link Operation (SLO). Thereby forcing the first MLD into SLO. Unlike MLO, SLO permits sending and receiving data over a single link, which can function to mitigate the detected anomaly.

The link transition trigger signals, according to various examples may be any signal indicating a transition a link from a non-active link to an active link. In some examples, a link transition trigger signal may be a PS polling signal. In another example, a link transition trigger signal may be a CTS signal following a RTS signal.

In various examples, de-authenticating of the second MLD may be responsive to determining that the plurality of link transition trigger signal satisfy a threshold, which is indicative of the anomaly. Thus, detecting the plurality of link transition trigger signal satisfy the threshold may be used to detect the anomaly. The threshold may be set as desired for a given application. In some examples, the threshold may be a threshold number of link transition trigger signals and the de-authenticating may be responsive the number of link transition trigger signals exceeding the threshold number. In another example, the threshold may comprise a set time interval, such that de-authenticating may be responsive to the number of link transition trigger signals exceeding the threshold number within the set time interval (e.g., a frequency of the link transition trigger signal exceeding a threshold frequency).

Accordingly, examples herein track anomalous behavior by monitoring how frequently or numerously an MLD is improperly attempting to use an active link, whether to waking up on the wrong link or maliciously spoofing a link transition trigger signal. Once an anomaly is detected, which is indicative of a denial-of-service is forth coming, the examples herein can reject multi-link associations and force the offending MLD into SLO. Once authenticated for SLO only, the offending MLD may be unable to flood a receiving MLD with link transitions, and ensure continued service, although over SLO.

It is noted that currently, Wi-Fi 7 is designed to offer communication over three bands (2.4 GHZ, 5 GHZ, 6 GHZ). However the present disclosure is not limited to only three bands, as more bands could be added in the future. Furthermore, examples herein are not limited to tracking link transition trigger signals on a single active link. Examples herein may aggregate link transition trigger signals received across all links to detect anomalous behavior.

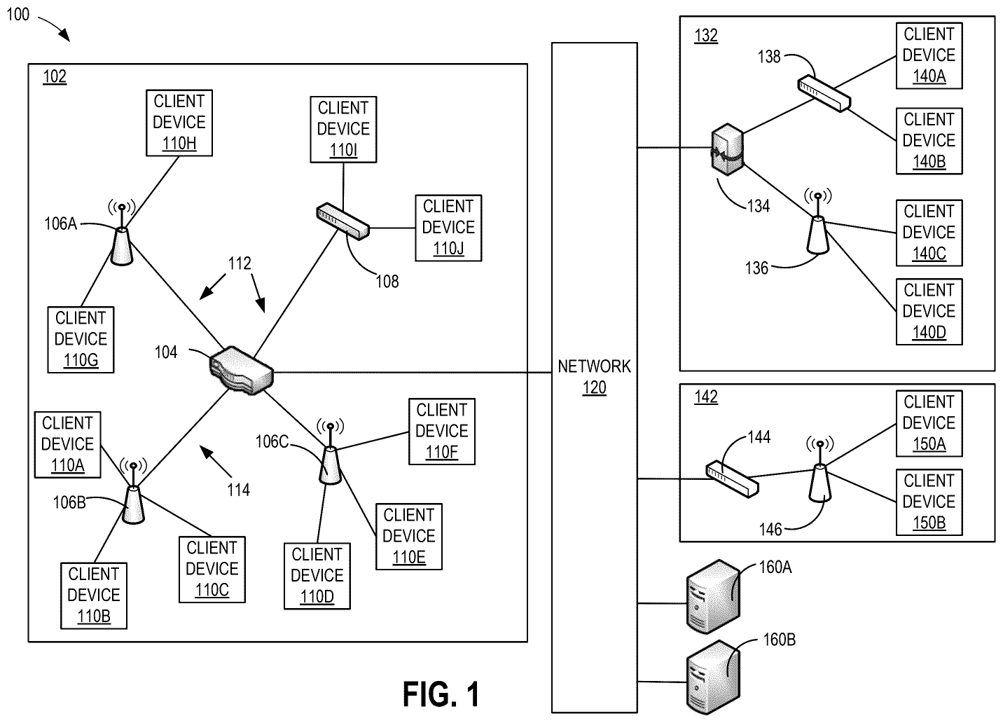

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, the primary site 102 includes a controller 104, which is in communication with the network 120. The controller 104 may provide communication with the network 120 for the primary site 102. There may be other points of communication with the network 120 for the primary site 102 in addition to controller 104. Although single controller 104 is illustrated, the primary site 102 may include multiple controllers and/or multiple communication points with network 120, any combination of which may be MLDs. In some embodiments, the controller 104 may communicate with the network 120 through a router, which may also be an MLD capable of multi-link tunnel communications that are compliant with the IEEE 802.11 standard. In other embodiments, the controller 104 provides router functionality to the devices in the primary site 102. In this specification, the word “tunnel” refers to an encapsulated mode of transporting data between AP and controller.

The controller 104 may be operable to configure and manage network devices, such as at the primary site 102, and may also manage network devices at the remote sites 132, 144. The controller 104 may be operable to configure and/or manage switches, routers, access points, and/or client devices connected to a network. The controller 104 may itself be, or provide the functionality of, an Access Point (AP). The controller 104 may be or include an MLD, which may be capable of multi-link tunnel communications compliant with the IEEE 802.11 standard.

The controller 104 may be in communication with one or more switches 108 and/or wireless Access Points (APs) 106a-c. Wireless APs 106a-c and switches 108 may also be an MLD that is capable of multi-link tunnel communications are compliant with the IEEE 802.11 standard. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired or wireless connection 112. In the illustrated example, the switch 108 communicates with the controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be a satellite office, another floor or suite in a building, for example. The remote site 132 may include a gateway device 134 for communicating with the network 120. A gateway device 134 may be a router, a digital-to-analog modem, a cable modem, a digital subscriber line (DSL) modem, or some other network device configured to communicate with the network 120. The remote site 132 may also include a switch 138 and/or AP 136 in communication with the gateway device 134 over either wired or wireless connections. The switch 138 and AP 136 provide connectivity to the network for various client devices 140a-d. Gateway device 134, AP 136, and switch 138, may be MLDs that are capable of multi-link tunnel communications compliant with the IEEE 802.11 standard.

In various embodiments, the remote site 132 may be in direct communication with primary site 102, such that client devices 140a-d at the remote site 132 access the network resources at the primary site 102 as if these client devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various embodiments, the network configuration 100 may include one or more smaller remote sites 142, comprising only a gateway device 144 for communicating with the network 120 and a wireless AP 146, by which various client devices 150a-b access the network 120. The gateway device 144 and the wireless AP 146 may be MLDs that are cable of multi-link tunnel communications compliant with the IEEE 802.11 standard. Such a remote site 142 may represent, for example, an individual employee's home or a temporary remote office. The remote site 142 may also be in communication with the primary site 102, such that the client devices 150a-b at the remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. The content servers 160a-b may include various providers of multimedia downloadable and/or streaming content, including audio, video, graphical, and/or text content, or any combination thereof. Examples of content servers 160a-b include web servers, streaming radio and video providers, and cable and satellite television providers. The client devices 110a-j, 140a-d, 150a-b may request and access the multimedia content provided by the content servers 160a-b. The content servers 160a-b may be MLDs that are cable of multi-link tunnel communications compliant with the IEEE 802.11 standard. The portions of network 120 and/or the individual sites 102, 132, 142, may utilize dynamic frequency selection (DFS) channels for communication. As an example, communication over a secure tunnel may exist between controller 104 and AP 106a-c. Having multi-link communications increase the throughput.

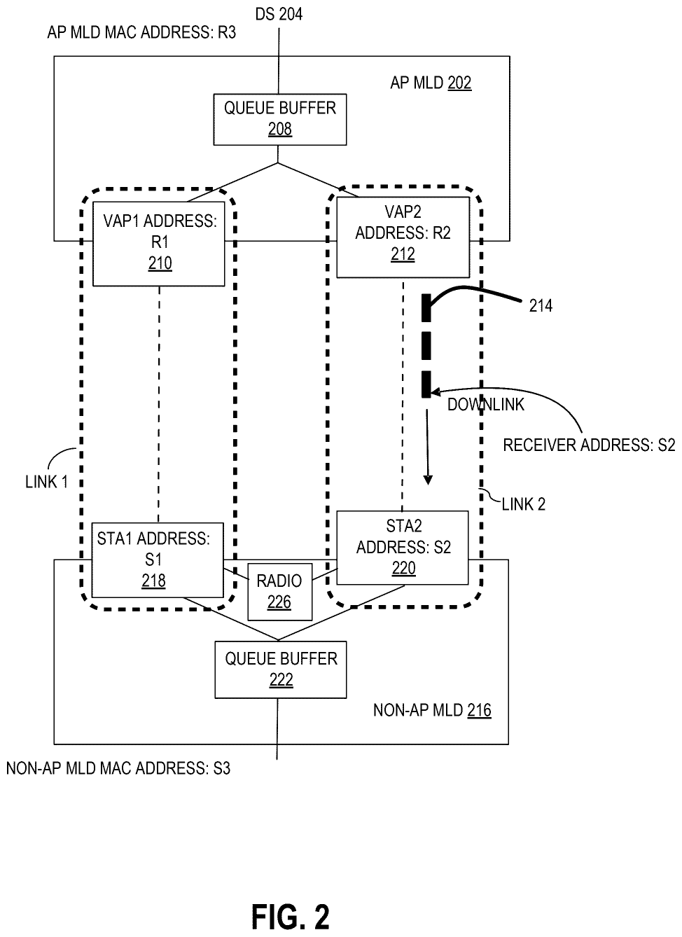

FIG. 2 illustrates an MLD communication. In FIG. 2 a message comes from a distribution system (DS) 204, such as a network, to an access point, AP MLD 202. In FIG. 2, a message from DS arrives at AP MLD 202 and waits in a queue buffer 208 to be sent to non-AP MLD 216. The message is sent via either Link 1 or Link 2. During multi-link operations (MLO), MLDs may operate multiple channels, each carrying a frequency (e.g., 2.4 GHZ, 5 GHZ, 6 GHz or other frequencies). Frames from a single traffic session can be sent on multiple links using an active link (Link 1 or Link 2). Each link may be a unique wireless channel (as defined in the 802.11 standard). If the message is sent via Link 1, the message is sent from address R1 across interface 210 to address S1 across interface 218. If the message (e.g., frame 214) is sent via Link 2, the message travels from address R2 across interface 212 to address S2 across interface 220. Whether the message arrives via interface 218 or 220, the message waits in a queue buffer 222, to be sent to DS. MLO allows a non-AP MLD 216 to send/receive data to/from AP MLD 202 over multiple links (Link 1 and Link 2). In the example of FIG. 2, a non-AP MLD 216 is associated with AP MLD 202 that is sending frames on the downlink (DL) on ‘Link 2’. In an example, Link 1 may be in the 2.4 GHz frequency band and Link 2 may be in the 5 GHz frequency band, but other frequency bands are possible. Additionally, while two links are shown in FIG. 2, this is for illustrative purposes only and one or more additional links may be established as part of the multi-association between AP MLD 202 and non-AP MLD 216.

In some implementations, the non-AP MLD 216 may be a single-radio device, referred to as an MLSR MLD device. The non-AP MLD 216 may transition the radio to alternatively communicate via one of the Link 1 and Link 2. When the a link (Link 2) is activated, the link may be promoted to become an active link for signaling purposes until deactivated and the link 1 is activated. Additionally, when one link is activated, the other link may become a non-active link by transitioning a radio chain interface of the link to a non-active state. For example, when Link 2 is an active link, Link 1 is a non-active link (e.g., interface 218 is in a non-active state) until Link 2 transitions to a non-active link and Link 1 is promoted to an active link. Thus, an active link may be the link that is currently activated and which the non-AP MLD 216 has an interface in an active state. To provide more flexibility, the IEEE 802.11be standards defined eMLSR operation to enable an MLSR MLD to dynamically switch links to improve both throughput and latency performance.

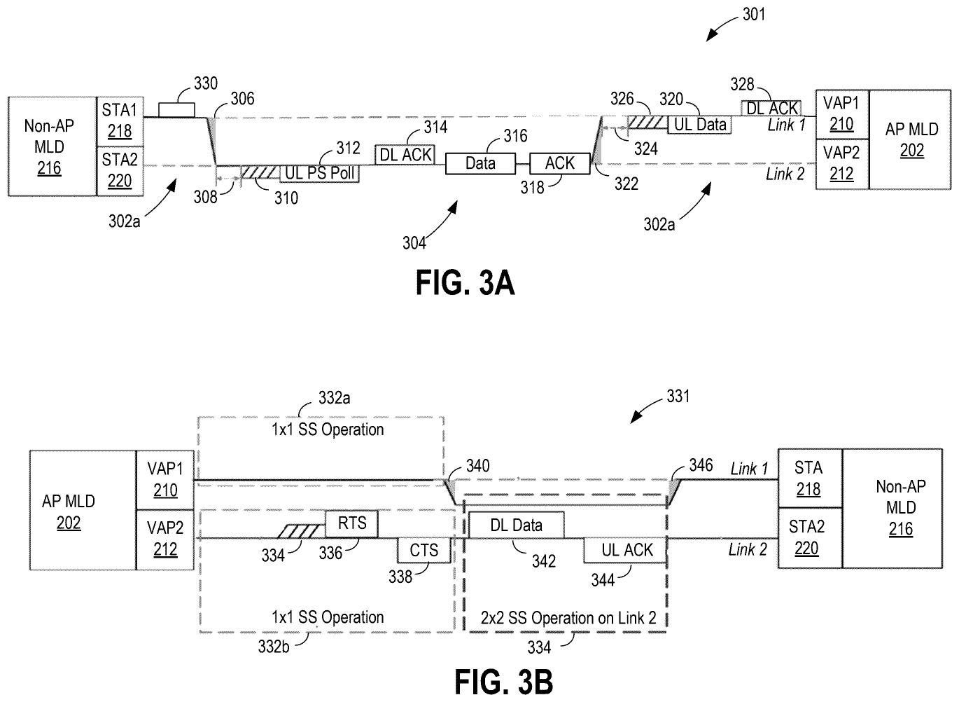

To transition a link from a non-active link to an active link, the MLD initiating the transition can send a link transition trigger signal to other MLD to notify an intent to switch a non-active link to an active link for sending data. Example of signaling a transition for an uplink transmission is provided below in connection with FIGS. 3A and 3B.

In the case of an MLSR device, each interface (e.g., interface 218 and interface 220) share a single radio 226 configured to use the multiple links (e.g., Link 1 and Link 2). The radio 226 may need to switch back and forth (e.g., transition) between the multiple links, for example, in a time domain multiplex (TDM) fashion, depending on which link is the active link. When Link 2 is the active link, radio 226 can be tuned to the frequency band corresponding to Link 2 (e.g., 5 GHz frequency band in this example). When Link 1 is the active link, radio 226 can be tuned to the frequency band corresponding to Link 1 (e.g., 2.4 GHz frequency band in this example). In the case of an eMLSR enabled device radio 226 may comprise multiple antennas eMLSR, each tuned to respective frequency band of the multiple links.

Sending data from a traffic session using the first available channel (selected from multiple channels) can improve throughput and reduce latency. The MLDs, AP MLD 202 and non-AP MLD 216, may be logical entities defined by the IEEE 802 family of standards to interface multiple MAC/physical layer (MAC/PHY) systems with each other. AP MLD 202 and non-AP MLD 216 may each have a single MAC layer-service access point (MAC-SAP) (not shown) interface to the upper layers, so that the upper layers do not need information about the links on which the MLD is operating. Within the MLD, there may be one or more link interfaces where each client device may be a MAC- PHY instance operating on a link. For example, the AP MLD 202 may be configured with virtual AP instances (e.g., VAP1 address and VAP2 address in this example), each operating on a link across a respective interface (e.g., interface 210 and interface 212). Similarly, the non-AP MLD 216 may be configured with MAC-PHY instances addressed according to a respective interface, e.g., a STA1 instance address operating across interface 218 and STA2 instance address operating across interface 220.

To make the operation efficient, authentication may be performed by the MLDs so that the non-AP MLD need not establish connections separately on each link, and the MLDs can perform a single setup for multiple links. For example, non-AP MLD 216 may transmit an authentication request on one of the links (link 1 or link 2) to request authentication for MLO with AP MLD 202. AP MLD 202 may access a context to verify that the non-AP MLD 216 is authorized for MLO and, if so, respond with an authentication response authorizing non-AP MLD 216 for MLO. Once authenticated, the MLDs can perform a single setup for multiple links to provide multi-link association and establish link 1 and link 2 therebetween.

In the example of FIG. 2, a collection of frames 214, which may be sent on the downlink (DL), can just as well be sent fully on ‘Link 1’ or fully on ‘Link 2. For example, in the case of MLSR devices, frames can be transmitted, for example, on both links by switching which link is the active link. This is because both the non-AP MLD 216 and AP MLD 202 exchange setup and response frames, including authentication for MLO, that establishes an association between the non-AP MLD 216 and a context at the AP MLD 202. The context may specify the capability of the sender and receiver and the policy for sending data frames, as well as include information that permits establishment of Link 1 and Link 2 and. In other words, the context allows frames 214 to be sent on either Links 1 and 2. Similarly, a collection of frames may be sent on the uplink (UL) using Link 1 or Link 2.

For the AP MLD 202, in addition to radio addresses R1 and R2, address R3 is defined which identifies the AP MLD entity. A similar address is defined for the non-AP MLD, which in this case is client device S3. The MLDs may be any device that has the capability to use the 802.11be standard, such as a laptop computer, a desktop PC, PDA access point or Wi-Fi phone. The MLD may be fixed, mobile, or portable. The MLD may be a transmitter or receiver, and the MLD may include a MAC and PHY interface to the wireless medium (WM).

FIG. 3A shows a schematic diagram of example signaling for data communications 301 in an MLO communication. FIG. 3A depicts a data communication 301 that can be implemented over MLD communication 200, and thus description of data communication 301 is made with reference to elements of FIG. 2. In the example of FIG. 3A, the non-AP MLD 216 may be implemented as an MLSR MLD.

In the example of FIG. 3A, the non-AP MLD 216 may transition Link 2 from a non-active state 302a to an active state 304, for example, by activating a corresponding interface (e.g., interface 220). There may be a transition delay 306 (such as a short interframe space duration) before the Link 2 is activated, for example, based on an amount of time for the non-AP MLD 216 to activate Link 2, as well as the amount of time for the non-AP MLD 216 to configure interface 220 accordingly. The non-AP MLD 216 may wait for a set link sync delay timer 308 to expire, which is to permit for the transition delay 306. After a random backoff block 310, the non-AP MLD 216 may send a PS Poll signal 312 via the activated link (e.g., Link 2 in this example) indicating a transition of the active link to Link 2 for the data communication. As the non-AP MLD 216 is sending the PS Poll signal 312 to the AP MLD 202, the PS Poll signal 312 can be referred to as a UL PS Poll signal.

The AP MLD 202 may respond with an acknowledgement (ACK) packet 314 or other signal to confirm that Link 2 is available for communication. In this case, the ACK packet 314 is a DL ACK message. Based on receipt of the ACK packet 314, data traffic 316 can be communicated via Link 2 as one or more data packets. While the data traffic 316 is communicated on Link 2, Link 1 may be blind to the data traffic because Link 1 may be a non-active link. Once data traffic 316 is received, an ACK packet 318 can be communicated on Link 2 acknowledging receipt of the data traffic 316. At some point (such as following a time period after the completion of the last data transmission), the non-AP MLD 216 may deactivate the Link 2 (non-active state 302b) and revert to Link 1, conserving power on Link 2. In the illustrative example, the non-AP MLD 216 may transmit UL data traffic 320 following a transition delay 322, a set link sync delay timer 324, and a random backoff block 326. The AP MLD 202 may respond with a DL ACK message 328 once the UL data traffic 320 is received.

In some examples, the data traffic 316 may be DL data traffic transmitted by the AP MLD 202 to the non-AP MLD 216. In this example, prior to the non-AP MLD 216 transitioning Link 2 to the active state 304, the AP MLD 202 may transmit a beacon frame 330 on Link 1 that that indicates DL data traffic is queued (e.g., buffered) for sending to a non-AP MLD. The beacon frame 330 may include, for example, a traffic indication map (TIM) element or a multi-cast traffic indication element that specifies a link of the multiple links for sending the queued data. In this example, the beacon frame 330, via the TIM element or a multi-cast traffic indication element, may specify that the DL data traffic (e.g., data traffic 316) is to be transmitted via Link 2. Based on the receiving the beacon frame 330, the non-AP MLD 216 wakes up interface 220 and transmits the PS Poll signal 312 triggering a link transition from Link 1 to Link 2. Data traffic 316 can be transmitted from the AP MLD 202 via Link 2 as DL data traffic and the non-AP MLD 216 may respond with a UL ACK as packet 318 on Link 2.

In other examples, the data traffic 316 may be UL data traffic transmitted to the AP MLD 202 by the non-AP MLD 216. In this example, the beacon frame 330 need not be transmitted as it is unnecessary for the AP MLD 202 to notify the non-AP MLD 216 of DL data traffic. Instead, the non-AP MLD 216 wakes up interface 220 and transmits the PS Poll signal 312 triggering a link transition from Link 1 to Link 2 for the UL data traffic. Data traffic 316 can be transmitted from the non-AP MLD 216 via Link 2 as UL data traffic and the AP MLD 202 may respond with a DL ACK as packet 318 on Link 2.

FIG. 3B shows a schematic diagram of another example signaling for data communications 331 in an MLO communication. FIG. 3B depicts a data communication 331 that can be implemented over MLD communication 200, and thus description of data communication 331 is made with reference to elements of FIG. 2.

In this example, the non-AP MLD 216 may be implemented as an eMLSR MLD. For example, the non-AP MLD 216 may have a single antenna having two or more antennas. The non-AP MLD 216 may use an antenna to concurrently sense for basic signals on both the Link 1 and Link 2. For example, the non-AP MLD 216 may use concurrent 1×1 (single antenna) subscriber stream (SS) operations 332a and 332b for detecting signals on Link 1 and Link 2, respectively, when the non-AP MLD 216 is idle (e.g., there is no data being communicated). Upon receiving an RTS signal form the AP MLD 202 or sending an RTS signal, the non-AP MLD 216 may switch from 1×1 SS operation on both links to a 2×2 SS operation 334 on one of the links by transition the one link to an active link. While in 2×2 SS operation 334, the other link is a non-active link and is blind to traffic on the active link. While the example of FIG. 3B is described for 1×1 SS and 2×2 SS operation, the examples herein are not intended to be limited to these operations, the non-AP MLD may be configured for n×n SS operation, where n is an integer equal to or greater than 1 (e.g., 4×4 SS, for 6×6 SS, etc.).

In the example in FIG. 3B, the AP MLD 202 may have queued DL data traffic for the non-AP MLD 216. The AP MLD 202 may initiate a DL data communication by sending an RTS signal 336, after a random backoff block 334, using Link 2. The RTS signal 336 in this case indicates data is queued for the non-AP MLD 216 for sending via Link 2. Based on (e.g., in response to) receiving the RTS signal 336, the non-AP MLD transmits a CTS signal 338 to the AP MLD 202 over Link 2, thereby triggering a transition of Link 2 to the active link and Link 1 to the non-active link. The RTS and CTS signals may be sent using single antenna (SS=1) communication. Upon receiving the RTS signal 336 and sending CTS signal 338, the non-AP MLD 216 switches from 1×1 SS operation on both links to 2×2 SS operation 334 on Link 2, waits for a transition delay 340, and receives DL data traffic 342 via Link 2. The non-AP MLD 212 responds by sending a UL ACK as packet 344 upon receiving the DL data traffic 342.

In another example, the non-AP MLD 216 may initiate UL communication by sending an RTS signal using one of the links (e.g., Link 2). The RTS signal in this case indicates UL data traffic is queued for the AP MLD 202 for sending via Link 2 and indicates a transition of Link 2 to the active link and Link 1 to the non-active link. The AP MLD 202 responds by transmitting a CTS signal over Link 2 confirming that Link 2 is transitioned to the active link. Upon sending the CTS signal, the non-AP MLD 216 switches from 1×1 SS operation on both links to 2×2 SS operation 334 on Link 2 and transmits the UL data traffic via Link 2. The AP MLD 202 responds by sending a DL ACK packet upon receiving the UL data traffic.

In some cases, an anomaly may occur related to an MLD that may negatively impact performance in the data communication described in connection with FIGS. 3A and 3B. For example, in some cases, the non-AP MLD 216 may active the wrong link by waking up an interface other than the one corresponding to the indicated link, which could result in de-synchronization between the AP MLD 202 and the non-AP MLD 216. In this case, a non-AP MLD 216 may transmit a PS Poll signal on a link that differs from the one specified by a beacon frame for DL data traffic or differs from the link designated for the TID of UL data traffic. As a result, the non-AP MLD 216 may transmit numerous repetitive PS Poll signals (e.g., FIG. 3A) or RTS/CTS signals (e.g., FIG. 3B). In another example, the non-AP MLD 216 may be spoofing the PS Poll signal and/or RTS/CTS signals by sending numerous repetitive signals, with an intention to negatively impact the AP MLD 202. In either case, the repetitive PS Poll signals and/or RTS/CTS signals can flood the AP MLD 202 with link transitions, which can result in a delays in communicating data traffic as well as a denial-of-service for the non-AP MLD 216.

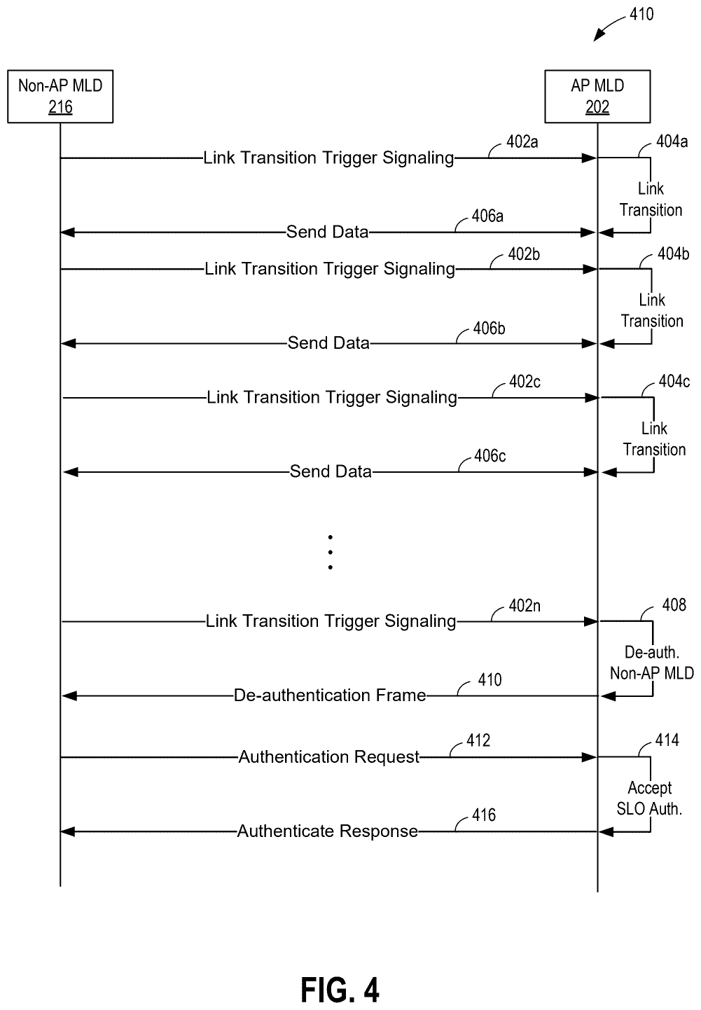

FIG. 4 depicts an example message flow diagram, reflecting operations performed for detecting anomalous behavior and protecting link transitions in MLO communications, in accordance with the implementations disclosed herein. FIG. 4 depicts a message flow 400 that can be implemented over MLD communication 200 for protecting link transitions of data communication 301 and/or 331, and thus description of message flow 400 is made with reference to elements of FIGS. 2-3B.

In examples, an anomaly related to the non-AP MLD 216 can be detected based on the AP MLD 202 receiving a plurality of link transition trigger signals from the non-AP MLD 216. For example, as shown in FIG. 4, the AP MLD 202 may receive a link transition trigger signal via messages 402a from the non-AP MLD 216. Based on (e.g., responsive to) receiving the link transition trigger signal provided as message 402a, the AP MLD 202 executes process 404a to transition communications with the non-AP MLD 216 to a link indicated by the link transition trigger signal provided as message 402a. Examples of the transitions are described above in connection with FIGS. 2-3B. Once transitioned, data packets can be sent/transmitted at message 406a. Message 406a may comprise one or more data transmissions. In a case where the AP MLD 202 has queued DL data for sending to the non-AP MLD 216, message 406a may include sending the DL data to the non-AP MLD 216, as described above in connection with FIGS. 3A and 3B. In a case where the non-AP MLD 202 has queued UL data for sending to the AP MLD 202, message 406a may include transmitting the UL data to the AP MLD 202, as described above in connection with FIGS. 3A and 3B.

Generally, as described above in connection with FIGS. 3A and 3B, after a ACK packet is received by either the AP MLD 202 or the non-AP MLD 216 once the data is received via message 406a. However, if there is an anomaly related to the non-AP MLD 216, such ACK may not be transmitted. As outlined above, this may be because the link transition trigger signal provided as message 402a may be spoofed by the non-AP MLD 216 or a de-synchronization may have occurred between the non-AP MLD 216 and the AP MLD 202. In either case, an ACK packet may not be transmitted confirming the receipt of the data via message 406a.

The link transition trigger signal provided as message 402a, according to various examples may be any signal(s) indicating or triggering a transition of a link to an active link. For example, the link transition trigger signal may be the PS Poll signal 312 of FIG. 3A. In another example, the link transition trigger signal may be a CTS signal sent following a RTS signal as described in connection with FIG. 3B. In some examples, the link transition trigger signal may be a Request-to-Send (RTS) signal, such as in the case of a UL data communication as described in connection with FIG. 3B.

Subsequent to message 406a, one or more additional link transition trigger signals may be received by the AP MLD 202 from the non-AP MLD 216. For example, as shown in FIG. 4A, the AP MLD 202 may receive link transition trigger signals 402b through 402n. Responsive to each link transition trigger signal 402b-402n, the AP MLD 202 executes processes 404b through 404n to perform corresponding link transitions and sends/receives data via respective messages 406b through 406c.

Based on (e.g., in response to) receiving the one or more link transition trigger signals 402a-402n the AP MLD 202 may detect the anomaly related to the non-AP MLD 216 due to the repetitious sending of link transition trigger signals 402a-402n. For example, the AP MLD 202 may comprise a counter that tracks the number of link transition trigger signals 402a-402n over a set interval of time. If the number of link transition trigger signals 402a-402n exceed a threshold number of link transition trigger signals, the AP MLD 202 may determine that there is an anomaly related to the non-AP MLD 216. The interval of time may be, for example, 30 seconds, 1 minute, 2 minutes, or any interval desired for a given application. The threshold may be set to any desired number, for example, 4, 5, 6, 10 link transition trigger signals, and so on. The interval of time and the threshold, which together may represent a frequency of receiving link transition trigger signals, may be set prior to receiving message 402a. In some examples, the interval of time and the threshold may be set when establishing multi-association between the non-AP MLD 216 and the AP MLD 202. In another example, the interval of time and the threshold may be set upon configuring the AP MLD 202 (e.g., prior to the multi-association).

Upon detecting the anomaly (e.g., responsive to receiving the link transition trigger signal 402n), the AP MLD 202 may de-authenticate 408 the non-AP MLD 216 for MLO with the AP MLD 202. De-authentication 408 may comprise tearing down or otherwise clearing the multi-association established between the AP MLD 202 and the non-AP MLD 216. For example, the AP MLD 202 may store a context for non-AP MLD 216, which may include information that sets forth the multi-association and permits establishment of the multiple links between the AP MLD 202 and the non-AP MLD 216. De-authentication 408 may include deleting/clearing this information from the context or otherwise changing the information to not permit the use of multiple links. The AP MLD 202 may update the context to indicate that the non-AP MLD 216 is not permitted for MLO with the AP MLD 202, and is only permitted for SLO.

Upon de-authenticating the non-AP MLD 216, the AP MLD 202 sends a message 410 to the non-AP MLD including a de-authentication frame. The de- authentication frames notifies the non-AP MLD 216 that it has been de-authenticated for MLO with the AP MLD 202 and that the multi-association therebetween has been torn down.

The de-authentication of the non-AP MLD 216 forces the non-AP MLD 216 to re-authenticate itself with the AP MLD 202 in order to perform any future data communications. Accordingly, the non-AP MLD 216 sends an authentication request 412 to the AP MLD 202. The authentication request 412 may include information requesting authentication for MLO and re-establishing of the multi-association.

Upon receiving the authentication request 412, the AP MLD 202 executes process 414 to re-authenticate the non-AP MLD 216 for data communications. At process 414, the AP MLD 202 may access the context to check if the non-AP MLD 216 is authorized for MLO. However, in this case, responsive to detecting the anomaly (e.g., receiving a plurality of link transition trigger signals 402a-402n), the context for the non-AP MLD 216 indicates that MLO is restricted (e.g., not permitted). As such, the AP MLD 202 may execute process 414 to authenticate the non-AP MLD 216 for SLO and restrict the non-AP MLD 216 from MLO.

The AP MLD 202 then transmits an authentication response 416 that notifies the non-AP MLD 216 that it is authenticated for SLO. The authentication response 416 may also notify the non-AP MLD 216 that is restricted (e.g., not permitted) for MLO with the AP MLD 202. As a result, the non-AP MLD 216 may be restricted to SLO only. While the non-AP MLD 216 is restricted to SLO, the AP MLD 202 may reject any requests for establishing more than one link with the non-AP MLD 216. In some examples, the restriction to SLO only may be for a set wait period of time (e.g., 1 hour, 1 day, etc.), after which the non-AP MLD 216 may be permitted for MLO with the AP MLD 202. For example, the non-AP MLD 216 may transmit a request to authenticate it for MLO operation. The AP MLD 202 may check the context and confirm that the wait period of time has elapsed and, if so, authenticate the non-AP MLD 216 for MLO and establish a multi-association, as described above.

Based on the authentication response 416, the AP MLD 202 and the non-AP MLD 216 may exchange setup and response frames to provision or configure a single link. The single link may then be used for data communications according to known SLO techniques.

By restricting the non-AP MLD 216 to SLO, the AP MLD 202 can mitigate anomalous behavior by the non-AP MLD 216 that could flood the AP MLD 202 with link transitions. Thus, the link transitions at the AP MLD 202 can be protected and avoid denial-of-services. While the non-AP MLD 216 is no longer authorized or otherwise permitted for MLO, services can still be permitted to the non-AP MLD 216 through the SLO. This may reduce throughput and increase latency at the non-AP MLD 216, but data communications are permitted until the anomaly can be resolved.

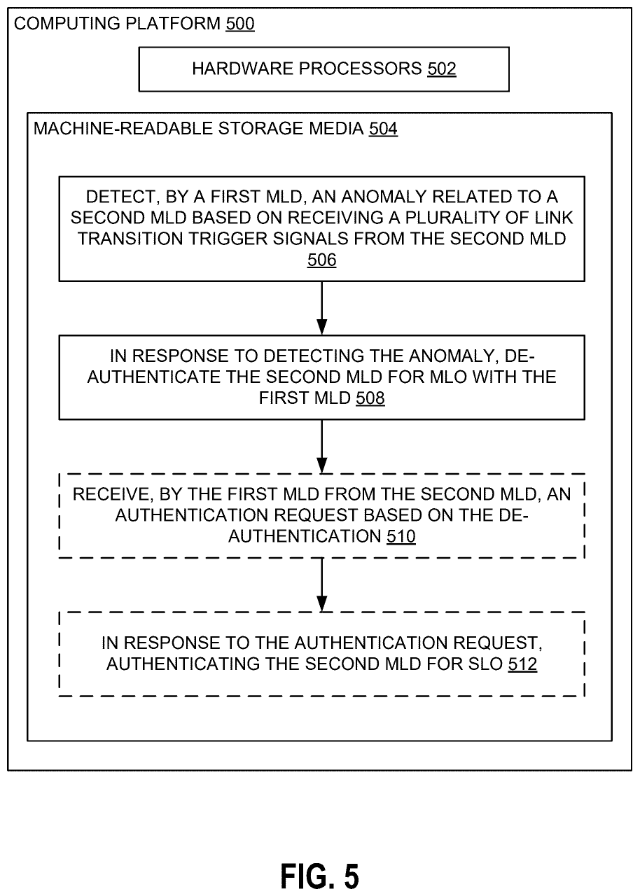

FIG. 5 illustrates an example computing component that may be used to implement detect anomalous behavior and protect link transitions in accordance with various embodiments. Referring now to FIG. 5, computing component 500 may be, for example, a server computer, a controller, or any other similar computing component capable of processing data. In the example implementation of FIG. 5, the computing component 500 includes a hardware processor 502, and machine-readable storage medium for 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-512, to control processes or operations for detecting anomalous behavior and protecting link transitions. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-512.

Hardware processor 502 may execute instruction 506 to detect, by a first MLD, an anomaly related to a second MLD based on receiving a plurality of link transition trigger signals from the second MLD. The second MLD may be authenticated for MLO with the first MLD, as described above in connection with FIGS. 1-3B. In an example, the first MLD may be an AP MLD (e.g., AP MLD 202) and the second MLD may be a non-AP MLD (e.g., non-AP MLD 216). The plurality of link transition trigger signals, in some examples, may be a PS Poll signal, a RTS signal, and/or a CTS signal, for example, as described above in connection with FIG. 4. The anomaly may be, for example, a de-synchronization between the first and second MLD or the second MLD may be spoofing a link transition trigger signal, both of which flood the first MLD with numerous link transition trigger signals.

In some examples, instruction 506 may include determining that the plurality of link transition trigger signals satisfy a threshold. For example, the plurality of link transition may comprise a number of link transition trigger signals. The number may be compared to a threshold number to determine that the number of link transition trigger signals is greater than or otherwise exceeds a threshold number. Based on the determination (e.g., in response to), instruction 506 may determine that the plurality of link transition trigger signals are indicative of the anomaly. In examples, the threshold may be a threshold frequency. In this case, if the number of link transition trigger signals received by the first MLD within a set time interval exceeds a threshold frequency (e.g., number for a given time interval), instruction 506 may determine that the plurality of link transition trigger signals is indicative of an anomaly.

Hardware processor 502 may execute instruction 508 to, in response to detecting the anomaly at instruction 506, de-authenticate the second MLD for MLO with the first MLD. For example, as described above in connection with FIG. 4, instruction 508 may include updating a context at the first MLD to restrict the second MLD from MLO and tear down the multi-association between the first and second MLD. Instruction 508 may include transmitting a de-authentication frame to the second MLD indicating that the second MLD has been de-authenticated for communication's with the first MLD.

Hardware processor 502 may execute optional instruction 510 to receive an authentication request, from the second MLD, based on (e.g., in response to) de-authentication at instruction 508. For example, based on (e.g., in response to) receiving the de-authentication frame, the second MLD may transmit an authentication request to the first MLD. The first MLD may process to authenticate by checking the context for the second MLD, which may indicate that the second MLD is not authorized or permitted for MLO operation at this time.

Hardware processor 502 may execute optional instruction 512 to, in response to the authentication request, authenticate the second MLD for SLO. For example, upon determining that the second MLD is not authorized for MLO operation, instruction 512 may authenticate the second MLD for SLO operation only and transmit an authentication request to the second MLD authorizing SLO operation only. Based on the authentication response, the second MLD may exchange setup signals to provision or configure a single link. If the second MLD sends any requests for establishing multiple links, instruction 512 may include rejecting such requests. In some examples, after a wait period has expired, the second MLD may be authenticated for MLO operation with the first MLD.

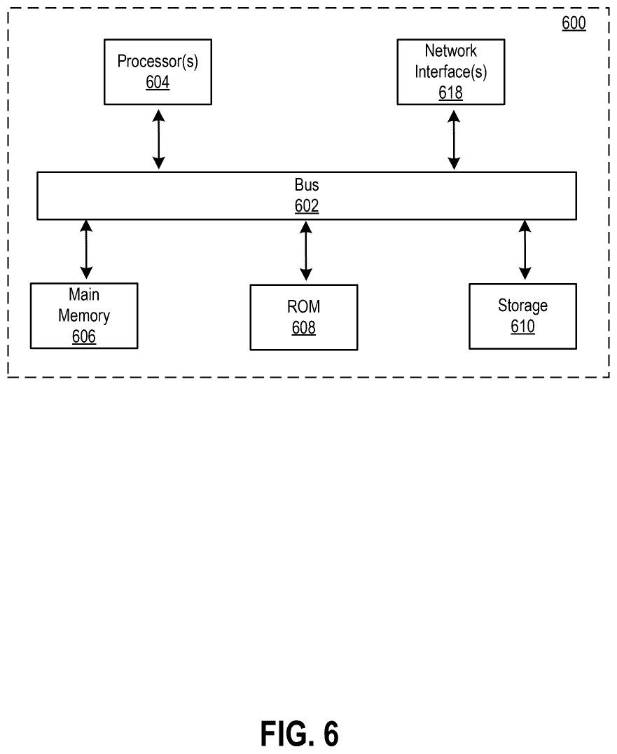

FIG. 6 depicts a block diagram of an example computer system 600 in which various of the embodiments described herein may be implemented. Computer system 600 may be implemented as any of the components of network configuration 100 (e.g., a client device, an AP, a switch, a controller, etc.); an MLD (e.g., AP MLD 202 and/or non-AP MLD 216 of FIG. 2), and so on. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. In an example, main memory 606 may comprise one or more of instructions 506-512 of FIG. 5 and/or instructions for executing operations described in connection with FIGS. 2-4. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Communication interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN (or WAN component to communicated with a WAN). Wireless links may also be implemented. In any such implementation, communication interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
detecting, by a first multi-link device (MLD), an anomaly related to a second MLD based on receiving a plurality of link transition trigger signals from the second MLD, wherein the second MLD is authenticated for multi-link operation (MLO) with the first MLD; and
in response to detecting the anomaly, de-authenticating the second MLD for MLO with the first MLD.

2. The method of claim 1, further comprising:
receiving, by the first MLD from the second MLD, an authentication request based on the de-authentication; and
in response to the authentication request, authenticating the second MLD for single-link operation (SLO).

3. The method of claim 2, further comprising:
authenticating the second MLD for only single-link operation.

4. The method of claim 2, further comprising:
activating a first link based on authenticating the second MLD for SLO; and
rejecting a request to activate a second link.

5. The method of claim 1, wherein the de-authenticating of the second MLD is responsive to determining that the plurality of link transition trigger signals satisfy a threshold.

6. The method of claim 5, wherein the plurality of link transition trigger signals comprises a number of link transition trigger signals, and wherein determining that the plurality of link transition trigger signals satisfy a threshold comprises determining that the number of plurality of link transition trigger signal is greater than a threshold number.

7. The method of claim 6, wherein determining that the plurality of link transition trigger signal satisfy a threshold comprises determining that the number of plurality of link transition trigger signal is greater than a threshold number within a set time interval.

8. The method of claim 1, wherein the plurality of link transition trigger signals are received via one or more links of a plurality of links between the first MLD and the second MLD, wherein de-authenticating the second MLD for MLO with the first MLD comprises tearing down the plurality of links.

9. The method of claim 1, further comprising, after a wait period:
receiving a request to authenticate the second MLD for MLO with the first MLD; and
authenticating the second MLD for MLO with the first MLD.

10. The method of claim 1, wherein the first MLD is an access point (AP) MLD and the second MLD is a non-AP MLD.

11. The method of claim 1, wherein the plurality of link transition trigger signals comprises at least one of a power save poll signal, a Request-to-Send signal, and a Clear-to-Send signal.

12. An access point (AP) comprising:
a memory storing instructions; and
a hardware processor communicatively coupled to the memory and configured to execute the instructions to:
receive, from a multi-link device (MLD), a plurality of link transition trigger signals, wherein the MLD is authenticated for multi-link operation (MLO); and
based on receiving plurality of the link transition trigger signals, de- authenticate the MLD for MLO.

13. The AP of claim 12, wherein the plurality of link transition trigger signals comprises at least one of a power save poll signal, a Request-to-Send signal, and a Clear-to-Send signal.

14. The AP of claim 12, wherein the MLD is one of a multi-link single radio (MLSR) device and an enhanced MLSR device.

15. The AP of claim 12, wherein the hardware processor is further configured to execute the instructions to:
transmit a de-authentication frame to the MLD based on de-authenticating the MLD;
receive, from the MLD, an authentication request responsive to the de- authentication frame; and
in response to the authentication request, authenticate the MLD for single-link operation (SLO).

16. The AP of claim 12, wherein de-authenticating the MLD is responsive to determining that the plurality of link transition trigger signals satisfy a threshold.

17. A system comprising:
a memory storing instructions; and
a hardware processor communicatively coupled to the memory and configured to execute the instructions to:
receive, by an access point (AP) multi-link device (MLD), a plurality of link transition trigger signals from a non-AP MLD configured for multi-link operation (MLO);
detect, by the AP MLD, an anomaly related to the non-AP MLD based on the plurality of link transition trigger signals exceeding a threshold; and
in response to detecting the anomaly, de-authenticate the non-AP MLD for MLO with the AP MLD and configure the non-AP MLD for single-link operation (SLO) only.

18. The system of claim 17, wherein the non-AP MLD is one of a multi-link single radio (MLSR) device and an enhanced MLSR device.

19. The system of claim 17, wherein the plurality of link transition trigger signals comprises at least one of a power save poll signal, a Request-to-Send signal, and a Clear-to-Send signal.

20. The system of claim 17, wherein the threshold is a threshold number of link transition trigger signals for a set time interval.
